(19) United States
(12) Patent Application Publication
(10) Pub. No.: US 2026/0089775 A1
(43) Pub. Date: Mar. 26, 2026

(54) METHOD AND APPARATUS FOR INTERFACE MANAGEMENT IN NON-TERRESTRIAL NETWORK

(71) Applicant: Electronics and Telecommunications Research Institute, Daejeon (KR)

(72) Inventors: Sook Yang KANG, Daejeon (KR); You Sun HWANG, Daejeon (KR); Joohan PARK, Daejeon (KR); Myungsan BAE, Daejeon (KR); Hyung Deug BAE, Daejeon (KR); Jaesheung SHIN, Daejeon (KR); Jae Wook SHIN, Daejeon (KR); Chahyeon EOM, Daejeon (KR); Sung-Min OH, Daejeon (KR); Kwang Ryul JUNG, Daejeon (KR)

(73) Assignee: Electronics and Telecommunications Research Institute, Daejeon (KR)

(21) Appl. No.: 19/331,314

(22) Filed: Sep. 17, 2025

(30) Foreign Application Priority Data
Sep. 20, 2024 (KR) 10-2024-0127737
Aug. 22, 2025 (KR) 10-2025-0117497

(51) Int. Cl. H04W 76/10; H04W 84/06

(52) U.S. Cl. CPC H04W 76/10; H04W 84/06

(57) ABSTRACT

A method of a non-terrestrial base station may comprise: establishing an SCTP association with a first AMF entity; receiving, based on the established SCTP association, a next generation (NG) setup command message from the first AMF entity; establishing an NG interface with the first AMF entity according to the NG setup command message; and transmitting an NG setup complete message to the first AMF entity upon completing establishment of the NG interface.

### CROSS-REFERENCE TO RELATED APPLICATIONS

This application claims priority to Korean Patent Applications No. 10-2024-0127737, filed on Sep. 20, 2024, and No. 10-2025-0117497, filed on Aug. 22, 2025, with the Korean Intellectual Property Office (KIPO), the entire contents of which are hereby incorporated by reference.

### BACKGROUND

### 1. Technical Field

The present disclosure relates to a technique for managing interfaces in a non-terrestrial network, and more particularly, to an interface management technique in a non-terrestrial network, which provides continuous connectivity between a base station installed in a satellite and a terrestrial network.

### 2. Related Art

In order to process the rapidly increasing wireless data traffic, communication networks that use frequency bands higher than those used in Long Term Evolution (LTE) or LTE-A (e.g. frequency bands below 6 GHz) are being considered. Such networks include New Radio (NR) communication networks, which can support not only frequency bands below 6 GHz but also those above 6 GHz. Compared to LTE communication networks, an NR communication network can support a wider variety of communication services and scenarios. For example, usage scenarios of NR communication networks may include enhanced Mobile Broadband (eMBB), Ultra-Reliable Low-Latency Communication (URLLC), and massive Machine-Type Communication (mMTC).

NR communication networks can provide communication services to terrestrial terminals. Recently, the demand for communication services has been increasing not only for terrestrial terminals but also for non-terrestrial terminals, such as terminals on airplanes, drones, and satellites. In response, technologies for non-terrestrial networks (NTNs) are being discussed. A non-terrestrial network may be implemented based on NR technology. For example, communication between a satellite and a communication node located on the ground, or a communication node located in a non-terrestrial environment (such as an airplane or drone), may be performed based on NR technology. In a non-terrestrial network, a satellite may perform the functions of a base station in the NR communication network.

Meanwhile, 3GPP proposed a regenerative satellite-based base station architecture when introducing non-terrestrial networks. In this architecture, a base station installed in a satellite moves along with the satellite, and the location of the serving base station may therefore change. The satellite-mounted base station may repeatedly establish and release connections with the access and mobility management function (AMF). Accordingly, the interface between the satellite-mounted base station and the AMF may require continuous management.

### SUMMARY

The present disclosure for resolving the above-described problems is directed to providing methods and apparatuses for interface management in a non-terrestrial network, which provide continuous connectivity between a base station installed in a satellite and a terrestrial network.

A method of a non-terrestrial base station, according to a first exemplary embodiment of the present disclosure, may comprise: establishing a stream control transmission protocol (SCTP) association with a first access and mobility management function (AMF) entity; receiving, based on the established SCTP association, a next generation (NG) setup command message from the first AMF entity; establishing an NG interface with the first AMF entity according to the NG setup command message; and transmitting an NG setup complete message to the first AMF entity upon completing establishment of the NG interface.

The NG setup command message may include at least one of information on a globally unique AMF identifier (GUAMI) or information on tracking areas of the non-terrestrial base station.

The method may further comprise: before receiving the NG setup command message from the first AMF entity based on the established SCTP association, establishing a feeder link between the non-terrestrial base station and a gateway connected to the first AMF entity.

The method may further comprise: receiving an NG removal command message from a second AMF entity; removing the NG interface according to the NG removal command message; and transmitting an NG removal complete message to the second AMF entity upon completing removal of the NG interface.

The NG removal command message may include information on a transport network layer (TNL) list for establishing a new NG interface of a neighbor AMF entity, and the NG removal complete message may include user equipment (UE) context information of a terminal whose mobility handling has not been completed by the non-terrestrial base station.

A method of a first AMF entity, according to a second exemplary embodiment of the present disclosure, may comprise: receiving movement path information including information on a time-based location of a non-terrestrial base station from an operation and maintenance center; determining a start time of service provision of the non-terrestrial base station for a management area based on the movement path information; and performing a next generation (NG) setup procedure to establish an NG interface with the non-terrestrial base station based on the determined start time of service provision.

The performing of the NG setup procedure may comprise: transmitting an NG setup command message to the non-terrestrial base station; establishing the NG interface based on the NG setup command message; and receiving an NG setup complete message from the non-terrestrial base station upon completion of establishment of the NG interface.

The NG setup command message may include at least one of information on a globally unique AMF identifier (GUAMI) or information on tracking areas of the non-terrestrial base station.

The method may further comprise: before performing the NG setup procedure, receiving information on tracking areas managed by the non-terrestrial base station from the operation and maintenance center, wherein the first AMF entity may perform the NG setup procedure when a tracking area is included in the management area.

The method may further comprise: before performing the NG setup procedure, establishing a stream control transmission protocol (SCTP) association with the non-terrestrial base station.

The method may further comprise: determining an end time of service provision of the non-terrestrial base station for the management area based on the movement path information; and performing an NG removal procedure to remove the NG interface with the non-terrestrial base station based on the determined end time of service provision.

The performing of the NG removal procedure may comprise: transmitting an NG removal command message to the non-terrestrial base station; removing the NG interface according to the NG removal command message; and receiving an NG removal complete message from the non-terrestrial base station upon completion of the removal of the NG interface.

The NG removal command message may include information on a transport network layer (TNL) list of a neighbor AMF entity for establishing a new NG interface, and the NG removal complete message may include user equipment (UE) context information of a terminal whose mobility handling has not been completed by the non-terrestrial base station.

A non-terrestrial base station, according to a third exemplary embodiment of the present disclosure, may comprise: at least one processor, wherein the at least one processor may cause the non-terrestrial base station to perform: establishing a stream control transmission protocol (SCTP) association with a first access and mobility management function (AMF) entity; receiving, based on the established SCTP association, a next generation (NG) setup command message from the first AMF entity; establishing an NG interface with the first AMF entity according to the NG setup command message; and transmitting an NG setup complete message to the first AMF entity upon completing establishment of the NG interface.

The NG setup command message may include at least one of information on a globally unique AMF identifier (GUAMI) or information on tracking areas of the non-terrestrial base station.

The at least one processor may further cause the non-terrestrial base station to perform: before receiving the NG setup command message from the first AMF entity based on the established SCTP association, establishing a feeder link between the non-terrestrial base station and a gateway connected to the first AMF entity.

The at least one processor may further cause the non-terrestrial base station to perform: receiving an NG removal command message from a second AMF entity; removing the NG interface according to the NG removal command message; and transmitting an NG removal complete message to the second AMF entity upon completing removal of the NG interface.

The NG removal command message may include information on a transport network layer (TNL) list for establishing a new NG interface of a neighbor AMF entity, and the NG removal complete message may include user equipment (UE) context information of a terminal whose mobility handling has not been completed by the non-terrestrial base station.

According to the present disclosure, an AMF can proceed with an NG setup procedure with a non-terrestrial base station located within a satellite that starts providing services to a management area and can establish an NG interface. Accordingly, the non-terrestrial base station can rapidly acquire information necessary for providing services in the management area from the AMF and can promptly provide services to a terminal located in the management area.

In addition, according to the present disclosure, the AMF can proceed with an NG removal procedure with the non-terrestrial base station that terminates services in the management area and can release the NG interface. Accordingly, the non-terrestrial base station can promptly deliver user equipment (UE) context information required for providing services in the management area to the AMF, so that another base non-terrestrial base station can continuously provide services to the terminal.

### BRIEF DESCRIPTION OF DRAWINGS

FIG. 1 is a conceptual diagram illustrating a first exemplary embodiment of a non-terrestrial network.

FIG. 2 is a conceptual diagram illustrating a second exemplary embodiment of a non-terrestrial network.

FIG. 3 is a block diagram illustrating a first exemplary embodiment of an entity constituting a non-terrestrial network.

FIG. 4 is a conceptual diagram illustrating a third exemplary embodiment of a non-terrestrial network.

FIG. 5 is a conceptual diagram illustrating exemplary embodiments of a management method of an NG interface.

FIG. 6 is a sequence chart illustrating exemplary embodiments of an interface management method in a non-terrestrial network.

FIG. 7 is a sequence chart illustrating exemplary embodiments of an NG setup command procedure.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

In the present disclosure, a phrase including “when ˜” may be expressed as a phrase including “based on ˜” or “in response to ˜”. In other words, a phrase including “when ˜” may be interpreted as equivalent or similar to a phrase including “based on ˜” or “in response to ˜”.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication network to which exemplary embodiments according to the present disclosure are applied will be described. The communication system may be a non-terrestrial network (NTN), a 4G communication network (e.g. long-term evolution (LTE) communication network), a 5G communication network (e.g. new radio (NR) communication network), a 6G communication network, or the like. The 4G communication network, 5G communication network, and 6G communication network may be classified as terrestrial networks.

The NTN may operate based on the LTE technology and/or the NR technology. The NTN may support communications in frequency bands below 6 GHz as well as in frequency bands above 6 GHz. The 4G communication network may support communications in the frequency band below 6 GHz. The 5G communication network may support communications in the frequency band below 6 GHz as well as in the frequency band above 6 GHz. The communication network to which the exemplary embodiments according to the present disclosure are applied is not limited to the contents described below, and the exemplary embodiments according to the present disclosure may be applied to various communication networks (e.g. 4G communication network and/or 5G communication network’. Here, the term ‘communication network’ may be used in the same sense as ‘communication system’.

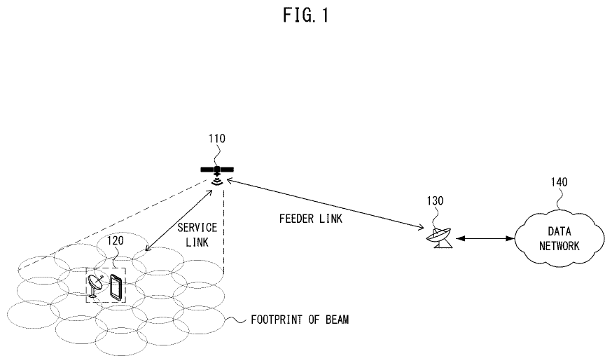

FIG. 1 is a conceptual diagram illustrating a first exemplary embodiment of a non-terrestrial network.

Referring to FIG. 1, a non-terrestrial network (NTN) may include a satellite 110, a communication node 120, a gateway 130, a data network 140, and the like. The NTN shown in FIG. 1 may be an NTN based on a transparent payload. The satellite 110 may be a low earth orbit (LEO) satellite (at an altitude of 300 to 1,500 km), a medium earth orbit (MEO) satellite (at an altitude of 7,000 to 25,000 km), a geostationary earth orbit (GEO) satellite (at an altitude of about 35,786 km), a high elliptical orbit (HEO) satellite, or an unmanned aircraft system (UAS) platform. The UAS platform may include a high altitude platform station (HAPS).

The communication node 120 may include a communication node (e.g. a user equipment (UE) or a terminal) located on a terrestrial site and a communication node (e.g. an airplane, a drone) located on a non-terrestrial space. A service link may be established between the satellite 110 and the communication node 120, and the service link may be a radio link. The satellite 110 may provide communication services to the communication node 120 using one or more beams. The shape of a footprint of the beam of the satellite 110 may be elliptical.

The communication node 120 may perform communications (e.g. downlink communication and uplink communication) with the satellite 110 using LTE technology and/or NR technology. The communications between the satellite 110 and the communication node 120 may be performed using an NR-Uu interface. When dual connectivity (DC) is supported, the communication node 120 may be connected to other base stations (e.g. base stations supporting LTE and/or NR functionality) as well as the satellite 110, and perform DC operations based on the techniques defined in the LTE and/or NR specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface or a satellite radio interface (SRI). The gateway 130 may be connected to the data network 140. There may be a ‘core network’ between the gateway 130 and the data network 140. In this case, the gateway 130 may be connected to the core network, and the core network may be connected to the data network 140. The core network may support the NR technology. For example, the core network may include an access and mobility management function (AMF), a user plane function (UPF), a session management function (SMF), and the like. The communications between the gateway 130 and the core network may be performed based on an NG-C/U interface.

Alternatively, a base station and the core network may exist between the gateway 130 and the data network 140. In this case, the gateway 130 may be connected with the base station, the base station may be connected with the core network, and the core network may be connected with the data network 140. The base station and core network may support the NR technology. The communications between the gateway 130 and the base station may be performed based on an NR-Uu interface, and the communications between the base station and the core network (e.g. AMF, UPF, SMF, and the like) may be performed based on an NG-C/U interface.

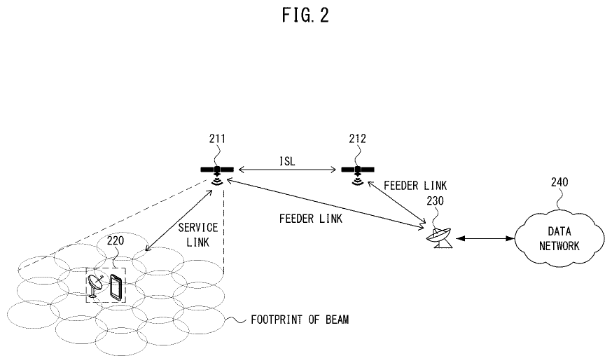

FIG. 2 is a conceptual diagram illustrating a second exemplary embodiment of a non-terrestrial network.

Referring to FIG. 2, a non-terrestrial network may include a first satellite 211, a second satellite 212, a communication node 220, a gateway 230, a data network 240, and the like. The NTN shown in FIG. 2 may be a regenerative payload based NTN. For example, each of the satellites 211 and 212 may perform a regenerative operation (e.g. demodulation, decoding, re-encoding, re-modulation, and/or filtering operation) on a payload received from other entities (e.g. the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g. UE or terminal) and a non-terrestrial communication node (e.g. airplane or drone). A service link (e.g. radio link) may be established between the satellite 211 and communication node 220. The satellite 211 may provide communication services to the communication node 220 using one or more beams.

The communication node 220 may perform communications (e.g. downlink (DL) communication or uplink (UL) communication) with the satellite 211 using LTE technology and/or NR technology. The communications between the satellite 211 and the communication node 220 may be performed using an NR-Uu interface. When DC is supported, the communication node 220 may be connected to other base stations (e.g. base stations supporting LTE and/or NR functionality) as well as the satellite 211, and may perform DC operations based on the techniques defined in the LTE and/or NR specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily.

The communications between each of the satellites 211 and 212 and the gateway 230 may be performed based on an NR-Uu interface or an SRI. The gateway 230 may be connected to the data network 240. There may be a core network between the gateway 230 and the data network 240. In this case, the gateway 230 may be connected to the core network, and the core network may be connected to the data network 240. The core network may support the NR technology. For example, the core network may include AMF, UPF, SMF, and the like. The communications between the gateway 230 and the core network may be performed based on an NG-C/U interface.

Alternatively, a base station and the core network may exist between the gateway 230 and the data network 240. In this case, the gateway 230 may be connected with the base station, the base station may be connected with the core network, and the core network may be connected with the data network 240. The base station and the core network may support the NR technology. The communications between the gateway 230 and the base station may be performed based on an NR-Uu interface, and the communications between the base station and the core network (e.g. AMF, UPF, SMF, and the like) may be performed based on an NG-C/U interface.

Meanwhile, entities (e.g. satellites, communication nodes, gateways, etc.) constituting the NTNs shown in FIGS. 1 and 2 may be configured as follows.

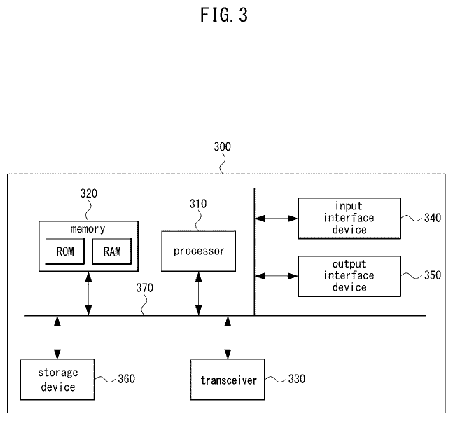

FIG. 3 is a block diagram illustrating a first exemplary embodiment of an entity constituting a non-terrestrial network.

Referring to FIG. 3, an entity 300 may include at least one processor 310, a memory 320, and a transceiver 330 connected to a network to perform communication. In addition, the entity 300 may further include an input interface device 340, an output interface device 350, a storage device 360, and the like. The components included in the entity 300 may be connected by a bus 370 to communicate with each other.

However, each component included in the entity 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

Meanwhile, scenarios in the NTN may be defined as shown in Table 1 below.

TABLE 1

| | NTN shown in FIG. 1 | NTN shown in FIG. 2 |
|---|---|---|
| GEO | Scenario A | Scenario B |
| LEO | Scenario C1 | Scenario D1 |
| (steerable beams) | | |
| LEO | Scenario C2 | Scenario D2 |
| (beams moving | | |
| with satellite) | | |

When the satellite 110 in the NTN shown in FIG. 1 is a GEO satellite (e.g. a GEO satellite that supports a transparent function), this may be referred to as ‘scenario A’. When the satellites 211 and 212 in the NTN shown in FIG. 2 are GEO satellites (e.g. GEOs that support a regenerative function), this may be referred to as ‘scenario B’.

When the satellite 110 in the NTN shown in FIG. 1 is an LEO satellite with steerable beams, this may be referred to as ‘scenario C1’. When the satellite 110 in the NTN shown in FIG. 1 is an LEO satellite having beams moving with the satellite, this may be referred to as ‘scenario C2’. When the satellites 211 and 212 in the NTN shown in FIG. 2 are LEO satellites with steerable beams, this may be referred to as ‘scenario D1’. When the satellites 211 and 212 in the NTN shown in FIG. 2 are LEO satellites having beams moving with the satellites, this may be referred to as ‘scenario D2’. Parameters for the scenarios defined in Table 1 may be defined as shown in Table 2 below.

TABLE 2

| | Scenarios A and B | | Scenarios C and D | |
|---|---|---|---|---|
| Altitude | 35,786 | km | 600 | km |

| | |
|---|---|
| 1,200 | km |

| Spectrum (service link) | <6 GHz (e.g. 2 GHz) | | |
|---|---|---|---|
| | >6 GHz (e.g. DL 20 GHz, UL 30 GHz) | | |
| Maximum channel bandwidth | 30 MHz for band <6 GHz | | |
| capability (service link) | 1 GHz for band >6 GHz | | |
| Maximum distance between | 40,581 | km | 1,932 km (altitude of 600 km) |
| satellite and communication | | | 3,131 km (altitude of 1,200 km) |
| node (e.g. UE) at the minimum | | | |
| elevation angle | | | |
| Maximum round trip delay | Scenario A: 541.46 ms (service | | Scenario C: (transparent |
| (RTD) | and feeder links) | | payload: service and feeder |
| (only propagation delay) | Scenario B: 270.73 ms (only | | links) |
| | service link) | | −5.77 ms (altitude of 60 0 km) |
| | | | −41.77 ms (altitude of 1,200 km) |
| | | | Scenario D: (regenerative |
| | | | payload: only service link) |
| | | | −12.89 ms (altitude of 600 km) |
| | | | −20.89 ms (altitude of 1,200 km) |
| Maximum delay variation | 16 | ms | 4.44 ms (altitude of 600 km) |
| within a single beam | | | 6.44 ms (altitude of 1,200 km) |
| Maximum differential delay | 10.3 | ms | 3.12 ms (altitude of 600 km) |
| within a cell | | | 3.18 ms (altitude of 1,200 km) |

| | |
|---|---|
| Service link | NR defined in 3GPP |
| Feeder link | Radio interfaces defined in 3GPP or non-3GPP |

In addition, in the scenarios defined in Table 1, delay constraints may be defined as shown in Table 3 below.

TABLE 3

| | Scenario | Scenario | Scenario | | Scenario | |
|---|---|---|---|---|---|---|
| | A | B | C1-2 | | D1-2 | |
| Satellite altitude | 35,786 km | | 600 km | | | |
| Maximum RTD in a | 541.75 ms | 270.57 ms | 28.41 | ms | 12.88 | ms |
| radio interface | (worst case) | | | | | |
| between base | | | | | | |
| station and UE | | | | | | |
| Minimum RTD in a | 477.14 ms | 238.57 ms | 8 | ms | 4 | ms |
| radio interface | | | | | | |
| between base | | | | | | |
| station and UE | | | | | | |

Hereinafter, methods for interface management in a communication system are described. Even when a method (e.g. transmission or reception of a signal) performed at a first communication node among communication nodes is described, a second communication node corresponding thereto may perform a method corresponding to the method performed at the first communication node (e.g. reception or transmission of the signal). That is, when an operation of a terminal is described, a base station corresponding thereto may perform an operation corresponding to the operation of the terminal. Conversely, when an operation of a base station is described, a terminal corresponding thereto may perform an operation corresponding to the operation of the base station. A base station may be located in a satellite. The base station located in the satellite may be referred to as a non-terrestrial base station. A terrestrial base station may refer to a base station located on the ground.

When introducing non-terrestrial networks, the 3GPP proposed two architectures as previously described: a transparent satellite-based base station architecture and a regenerative satellite-based base station architecture. A satellite payload in the transparent satellite-based base station architecture may perform frequency conversion and radio frequency amplification in uplink and downlink. In the transparent satellite-based base station architecture, a terrestrial base station may perform radio resource management, user context management, and user state management for providing services to terminals. In the transparent satellite-based base station architecture, the satellite payload may perform a role of delivering an NR-Uu radio interface signal transferred through a feeder link between an NTN gateway and the satellite to a terminal through a service link. Conversely, the transparent satellite-based base station may perform a role of delivering a signal received from the terminal to the NTN gateway.

A satellite payload of the regenerative satellite-based base station architecture may process functions such as radio resource management, user context management, and user state management for providing services to terminals. In the regenerative satellite-based base station structure, the satellite payload may perform a role of delivering an NR-Uu radio interface signal transferred through a feeder link between an NTN gateway and the satellite to a terminal through a service link. Conversely, the satellite payload in the regenerative satellite-based base station may perform a role of receiving a signal from a terminal and delivering the signal to the NTN gateway.

The present disclosure provides an interface management method between a base station and an access and mobility management function (AMF) in the regenerative satellite-based base station architecture among the two architectures described above. The terrestrial base station may be fixedly installed. Accordingly, an interface between the terrestrial base station and the AMF may not move. Initially configured parameters of the interface between the terrestrial base station and the AMF may be updated through an update procedure.

On the other hand, in the regenerative satellite-based base station architecture, a base station installed in a satellite may move along with movement of the satellite, and a location of the serving base station may change. The satellite-mounted base station may repeatedly establish and release connections with the AMF. Accordingly, the interface between the satellite-mounted base station and the AMF may require continuous management. The present disclosure has a purpose of providing an interface management method capable of processing connection and release at an accurate time in a situation where connection and release of an interface (hereinafter referred to as ‘NG interface’) between the non-terrestrial base station installed in the satellite and the AMF is repeated, and capable of providing continuous connection between the non-terrestrial base station installed in the satellite and a terrestrial network.

The NG interface between the non-terrestrial base station and the AMF may have the following several options.
Option 1: legacy procedure (e.g. stream control transmission protocol (SCTP) shutdown)
Option 2: removal/setup of NG interface
Option 3: suspend/resume of NG interface
Option 4: removal/setup of NG interface and suspend/resume of NG interface (including both Option 2 and Option 3)

The NG interface management may be mainly based on Option 2 of removal/setup of NG interface. However, the 3GPP is in discussion on Option 3. The present disclosure may be based on Option 2 of removal/setup of NG interface. The non-terrestrial base station may transmit an NG setup request message to the AMF. The AMF may receive the NG setup request message from the non-terrestrial base station. In such a situation, the non-terrestrial base station may require information such as information on supported tracking areas. The information on tracking areas may be, for example, a tracking area identity (TAI) list that the non-terrestrial base station supports. The tracking area information may change depending on a location. The non-terrestrial base station may not have all related information due to a limitation of storage space.

In order to solve such a problem, the non-terrestrial base station may attempt to acquire tracking area information from external sources. However, the non-terrestrial base station may require extensive signal transmission and reception to obtain such tracking area information, which may make timely and reliable information delivery difficult. To address this problem, the present disclosure proposes a method in which the AMF is responsible for setup and release of the NG interface, and initiation is performed by the AMF. When management of the NG interface is assigned to the AMF, the AMF may request connection and release at an accurate time by maximally utilizing information held in the network. As a result, connection failures between the non-terrestrial base station and the AMF can be reduced, thereby enabling simplified management of the NG interface.

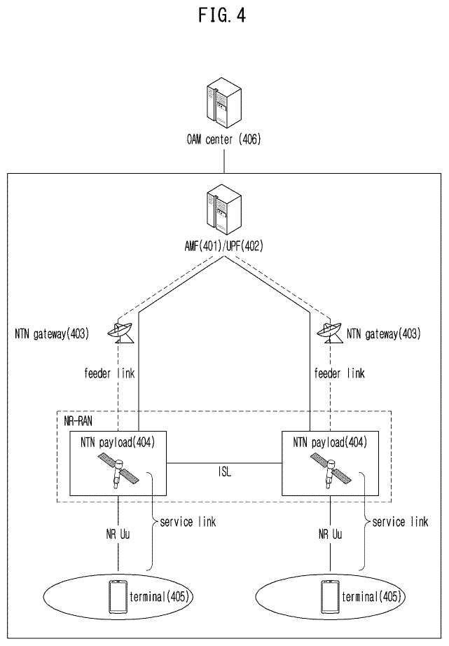

FIG. 4 is a conceptual diagram illustrating a third exemplary embodiment of a non-terrestrial network.

Referring to FIG. 4, a non-terrestrial network may include an AMF 401, a UPF 402, NTN gateways 403, NTN payloads 404, terminals 405, and an operation, administration, and maintenance (OAM) center 406. The AMF may be a core network node on the ground and is responsible for subscriber context management and mobility management. The AMF exchanges signals with a non-terrestrial base station of an NTN payload through an NG interface. The AMF may be, for example, an AMF entity.

The UPF handles data transmission and reception between a network node and the non-terrestrial base station of the NTN payload. The UPF is connected to an IP network. The NTN gateway is located on the ground and may be connected to the non-terrestrial base station of the NTN payload through a feeder link. The NTN payload may be a network node onboard a satellite, and may transmit and receive signals with a terminal through a service link according to an NR-Uu protocol. The non-terrestrial base station of the NTN payload may be connected to the NTN gateway through the feeder link, and the NTN payload has the functions of the non-terrestrial base station. The OAM center is responsible for overall operation and management of the system and exchanges necessary information with each node. The NTN payloads can be connected to one another through an ISL. The terminal and the NTN payload can communicate through an NR-Uu interface.

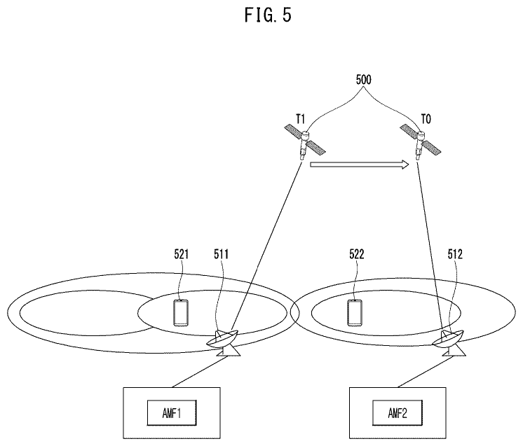

FIG. 5 is a conceptual diagram illustrating exemplary embodiments of a management method of an NG interface.

Referring to FIG. 5, at a time T0, a non-terrestrial base station installed in a satellite 500 may be located in a management area of AMF1. At the time T0, the non-terrestrial base station may be connected to AMF1 via an NTN gateway 511. At the time T0, the non-terrestrial base station may provide services to a terminal 521 located in the management area of AMF1. At the time T0, the terminal 521 located in the management area of AMF1 may receive services from the non-terrestrial base station.

As time elapses, the satellite may move. The non-terrestrial base station installed in the satellite may also move and may move from an area managed by AMF1 to an area managed by AMF2. In such a situation, the non-terrestrial base station may perform an NG removal procedure to stop services for the terminal 521. The non-terrestrial base station may perform an NG setup procedure with respect to AMF2 via the NTN gateway 512 in order to provide services for a terminal 522. At a time T1, the non-terrestrial base station may be connected to AMF2 via the NTN gateway 512. At the time T1, the non-terrestrial base station may provide services to the terminal 522 located in the management area of AMF2. At the time T1, the terminal 522 located in the management area of AMF2 may receive services from the non-terrestrial base station.

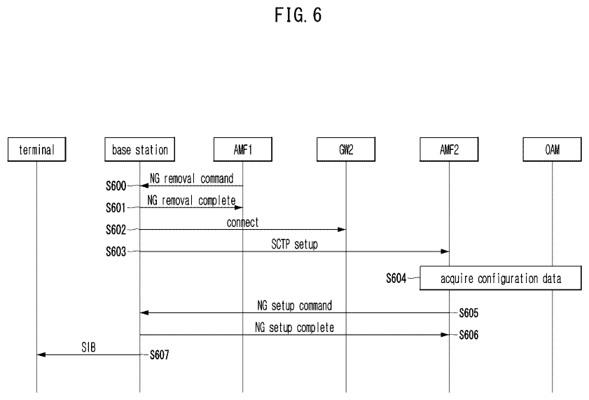

FIG. 6 is a sequence chart illustrating exemplary embodiments of an interface management method in a non-terrestrial network.

Referring to FIG. 6, at a time T0, a non-terrestrial base station installed in a satellite may be located in a management area of AMF1. At the time T0, the non-terrestrial base station may be connected to AMF1 via a first NTN gateway (GW1) (not shown). At the time T0, the non-terrestrial base station may provide services to a terminal located in the management area of AMF1. At the time T0, the terminal located in the management area of AMF1 may receive services from the non-terrestrial base station. As time elapses, the satellite may move. The non-terrestrial base station installed in the satellite may move and may move from the area managed by AMF1 into an area managed by AMF2. In such a situation, the non-terrestrial base station may perform an NG removal procedure to terminate the connection with AMF1.

An OAM center may provide AMF1 and AMF2 with movement path information including information on a location of the satellite by time. AMF1 and AMF2 may receive the movement path information including information on the location of the satellite by time from the OAM center. AMF1 may identify a start time and an end time of service provision for the management area of AMF1 by the non-terrestrial base station installed in the satellite based on the movement path information on the satellite.

AMF1 may initiate an NG removal procedure with the non-terrestrial base station installed in the satellite based on the end time of service provision for the management area of AMF1. AMF2 may initiate an NG setup procedure with the non-terrestrial base station installed in the satellite based on the start time of service provision of the non-terrestrial base station installed in the satellite for the management area of AMF2. AMF2 may transmit information on tracking areas of the non-terrestrial base station in an NG setup command based on OAM information, and the non-terrestrial base station installed in the satellite may broadcast the information on the tracking areas to terminals.

The NG removal procedure may be a procedure used when AMF1 removes an NG interface instance of an NG-RAN node (e.g. non-terrestrial base station). The NG removal procedure may be initiated by AMF1 and may use non-UE associated signaling.

In the NG removal procedure, AMF1 may transmit an NG removal command message to the non-terrestrial base station (S600). The NG removal command message may include a neighbor AMF transport network layer (TNL) list information element (IE) including information on TNLs of AMFs adjacent to AMF1. For example, the NG removal command may include at least one of information on a second gateway (GW2) or information on AMF2. The non-terrestrial base station may receive the NG removal command message from AMF1. The NG removal command message may include the AMF TNL list IE and may include, for example, at least one of information on GW2 or information on AMF2. The non-terrestrial base station may receive the NG removal command message from AMF1. The NG removal command message may be as shown in Table 4.

TABLE 4

| IE/Group | | | IE type and | Semantics | Criti- |
|---|---|---|---|---|---|
| Name | Presence | Range | reference | description | cality |
| Message Type | M | | 9.3.1.1 | Indicates a | YES |
| | | | | message type | |
| Global RAN | M | | 9.3.1.5 | Global identifier | YES |
| Node ID | | | | of NG-RAN node | |
| RAN Node Name | O | | PrintableString | Name of RAN node | YES |
| | | | (SIZE(1 . . . | | |
| | | | 150, . . . )) | | |
| Neighbor AMF | | 0 . . . 1 | — | TNL information list | YES |
| TNL list | | | | of neighbor AMFs | |
| >neighbor AMF | | 1 . . . | — | Items in the list | |
| TNL Item | | <maxnoofTNLAssociations> | | | |
| >>AMF TNL | M | | CP Transport | AMF transport layer | |
| Association | | | Layer Information | information used to | |
| Address | | | (9.3.2.6) | set up the new TNL | |
| | | | | association | |

The non-terrestrial base station may transfer UE context information of the terminal being served to a neighbor non-terrestrial base station according to the NG removal command. The non-terrestrial base station may transmit an NG removal complete message to AMF1 after completing transfer of the UE context information to the neighbor non-terrestrial base station (S601). Alternatively, the non-terrestrial base station may transmit UE context information that has not been transferred together with the NG removal complete message to AMF1 according to the NG removal command.

AMF1 may receive the NG removal complete message from the non-terrestrial base station. The NG removal complete message may be as shown in Table 5. The non-terrestrial base station may include UE context information related to the terminal being served in the NG removal complete message and may deliver the NG removal complete message to AMF1. AMF1 may receive and store the non-transferred UE context information from the non-terrestrial base station installed in the satellite. Thereafter, another non-terrestrial base station installed in a satellite may receive the UE context information from AMF1 and may provide services to the corresponding terminal.

TABLE 5

| IE/Group | | | IE type and | Semantics | | Assigned |
|---|---|---|---|---|---|---|
| Name | Presence | Range | reference | description | Criticality | criticality |
| Message | M | — | 9.3.1.1 | Indicates a | YES | Reject |
| Type | | | | message type | | |
| Global RAN | M | — | 9.3.1.5 | Global identifier | YES | Reject |
| Node ID | | | | of NG-RAN node | | |
| RAN Node | O | — | PrintableString | Name of RAN | YES | Ignore |
| Name | | | (SIZE(1 . . . | node | | |
| | | | 150, . . . )) | | | |
| UE context | O | | (0~maxNoOfUE) | Non-transferred | | Ignore |
| list | | | | UE context | | |
| | | | | information | | |

The non-terrestrial base station may access the second gateway based on the AMF TNL list IE included in the NG removal command (S602). The non-terrestrial base station may request a TNL address of AMF2 from the second gateway. The second gateway may receive the request for the TNL address from the non-terrestrial base station. The second gateway may transmit the TNL address of AMF2 to the non-terrestrial base station. The non-terrestrial base station may receive the TNL address from the second gateway. The non-terrestrial base station may proceed with an SCTP setup procedure with AMF2 based on the TNL address of AMF2 (S603) and may establish an SCTP association.

AMF2 may acquire configuration data from the OAM center (S604). AMF2 may identify a connection time of the non-terrestrial base station based on the configuration data acquired from the OAM center. AMF2 may complete the SCTP setup procedure with the non-terrestrial base station and may transmit an NG setup command message to the non-terrestrial base station (S605). The NG setup command message may include information required for establishing an NG interface. The non-terrestrial base station may receive the NG setup command message including the information required for establishing the NG interface. The non-terrestrial base station may complete establishment of the NG interface for AMF2 by using the information required for establishing the NG interface and may transmit an NG setup complete message to AMF2. AMF2 may receive the NG setup complete message from the non-terrestrial base station (S606). The NG setup command message may be as shown in Table 6 and Table 7. The NG setup command may further include information on tracking areas of the non-terrestrial base station located in the satellite.

TABLE 6

| | | | | | | |
|---|---|---|---|---|---|---|
| | | | IE type and | Semantics | | Assigned |
| IE/Group Name | Presence | Range | reference | description | Criticality | criticality |

| | | | | | |
|---|---|---|---|---|---|
| Message Type | M | — | 9.3.1.1 | YES | Reject |
| AMF Name | M | — | 9.3.1.21 | YES | Reject |
| Served GUAMI list | | 1 | | YES | Reject |
| >Served GUAMI item | | 1 . . . | | — | |
| | | <maxnoofServedGUAMIs> | | | |
| >>GUAMI | M | | 9.3.3.3 | — | |
| >>Backup AMF Name | O | | AMF | — | |
| | | | name(9.3.3.21) | | |
| >>GUAMI Type | O | | ENUMERATED | YES | Ignore |
| | | | (native, | | |
| | | | mapped, . . . ) | | |
| Relative AMF Capacity | M | | 9.3.1.32 | YES | Reject |
| PLMN Support List | | 1 | | YES | |
| >>PLMN identity | | 1 . . . | | — | |
| | | <maxnoofPLMNs> | | | |
| >>PLMN ID | M | | 9.3.3.5 | — | |

TABLE 7

| | | | | | | |
|---|---|---|---|---|---|---|
| | | | IE type and | Semantics | | Assigned |
| IE/Group Name | Presence | Range | reference | description | Criticality | criticality |

| | | | | | |
|---|---|---|---|---|---|
| >>Slice Support List | M | 9.3.1.17 | Supported S- | — | Reject |
| | | | NSSAIs per | | |
| | | | PLMN or per | | |
| | | | SNPN | | |
| >>NPN Support | O | 9.3.3.44 | If NID IE is | YES | Reject |
| | | | included, it | | |
| | | | identifies a | | |
| | | | SNPN | | |
| | | | together with | | |
| | | | the PLMN | | |
| | | | identity IE | | |
| >>Extended Slice | O | 9.3.1.191 | Additional | YES | Ignore |
| Support List | | | Supported S- | | |
| | | | NSSAIs per | | |
| | | | PLMN or per | | |
| | | | SNPN | | |
| | | | (addressing | | |
| | | | message size | | |
| | | | limitation) | | |
| >>Onboarding Support | O | ENUMERATED | Indication of | YES | Ignore |
| | | (true, . . . ) | onboarding | | |
| | | | support | | |
| Criticality Diagnostics | O | 9.3.1.3 | | YES | Ignore |
| UE Retention | O | 9.3.1.117 | | YES | Ignore |
| Information | | | | | |
| Integrated Access & | O | ENUMERATED | Indication of | YE | Ignore |
| Backhaul (IAB) | | (true, . . . ) | support for | | |
| Supported | | | IAB | | |
| Extended AMF Name | O | 9.3.3.51 | | YES | Ignore |
| Mobile IAB Supported | O | ENUMERATED | Indication of | YES | Ignore |
| | | (true, . . . ) | support for | | |
| | | | mobile IAB | | |

AMF2 may receive the NG setup complete message from the non-terrestrial base station (S606). The NG setup complete message may be as shown in Table 8.

TABLE 8

| | | | | | | |
|---|---|---|---|---|---|---|
| IE/Group | | | IE type and | | | Assigned |
| Name | Presence | Range | reference | Semantics description | Criticality | criticality |

| | | | | | |
|---|---|---|---|---|---|
| Message | M | 9.3.1.1 | Indicates a message | YES | Reject |
| Type | | | type | | |
| Global | M | 9.3.1.5 | Global identifier of NG- | YES | Reject |
| RAN Node | | | RAN node | | |
| ID | | | | | |
| RAN Node | O | PrintableString | Name of RAN node | YES | Ignore |
| Name | | (SIZE(1 . . . | | | |
| | | 150, . . . ) | | | |

A purpose of such an NG setup command procedure may be to exchange application layer data required for the NG-RAN node (e.g. non-terrestrial base station) and AMF2 to correctly interoperate in an NG-control plane (NG-C) interface. The NG setup command message may be a message for initial setup between the NG-RAN (Node B or gNB) and AMF2. The NG setup command procedure may be an essential initial data exchange procedure for securing interoperability in the NG-C interface. Another TNL association may be in an operable state in the regenerative payload. The TNL association may be a physical/logical association based on SCTP. The NG-C interface may require an active TNL association to operate. The NG setup command procedure may be the first NGAP procedure triggered and executed by AMF2. The NG setup command procedure may use non-UE associated signaling. The non-UE associated signaling may be signaling for network configuration/management unrelated to a specific user session.

A backup AMF name IE may indicate a name of a backup AMF to be used in a case of a failure or reselection situation of AMF2 and may be available. In such a case, AMF2 may include the backup AMF name IE in a served globally unique AMF identifier (GUAMI) list IE of the NG setup command message. The GUAMI is an identifier that uniquely identifies an AMF worldwide. A GUAMI type IE may indicate a format/type of the ID. When supported, the NG-RAN node may consider an AMF specified by the backup AMF name IE when performing AMF reselection.

The GUAMI type IE may be included in the NG setup command message. In such a case, the NG-RAN node may store a received value and may use the GUAMI type IE for subsequent AMF selection. When there is a need to retrieve UE context information from a previous NG-RAN node, AMF2 may include an NG-RAN node ID. The retrieval of UE context information may be a process of acquiring a connection state, session information, and the like of the terminal stored in the previous NG-RAN node.

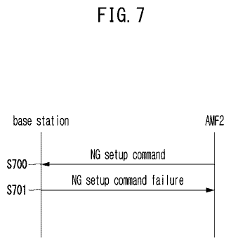

FIG. 7 is a sequence chart illustrating exemplary embodiments of an NG setup command procedure.

Referring to FIG. 7, AMF2 may complete the SCTP setup procedure with the non-terrestrial base station and may transmit an NG setup command message to the non-terrestrial base station (S700). The non-terrestrial base station may receive the NG setup command message from AMF2.

The non-terrestrial base station may not accept the NG setup command. In this case, the non-terrestrial base station may transmit an NG setup command failure message including a cause value to AMF2 (S701). AMF2 may transmit an NG setup command message to another NG-RAN. The NG setup command failure message may be an error response message transmitted when the non-terrestrial base station cannot process the initial setup request of AMF2. The cause value may indicate ‘unsupported function’, ‘configuration mismatch’, ‘lack of resources’, ‘security failure’, or the like. The NG setup command failure message may include a cause IE and may clearly indicate a reason for rejection. Table 9 may illustrate the NG setup command failure message.

TABLE 9

| IE/Group | | | | Semantics | | Assigned |
|---|---|---|---|---|---|---|
| Name | Presence | Range | IE type and reference | description | Criticality | criticality |
| Message | M | — | 9.3.1.1 | Indicates a message | YES | Reject |
| Type | | | | type | | |
| Global | M | — | 9.3.1.5 | Global identifier of | YES | Reject |
| RAN Node | | | | NG-RAN node | | |
| ID | | | | | | |
| RAN Node | O | — | PrintableString | Name of RAN node | YES | Ignore |
| Name | | | (SIZE(1 . . . | | | |
| | | | 150, . . . )) | | | |
| Cause | M | — | 9.3.1.2 | | YES | Ignore |

AMF2 may retransmit the same NG setup command to another NG-RAN to maintain services through another RAN node in case of a network failure. When the initial NG-C interface setup fails, the NG-RAN does not form an NG-C connection and therefore cannot exchange control messages. Accordingly, AMF2 may attempt to connect with another candidate NG-RAN to ensure continuity of network service.

Referring again to FIG. 6, the non-terrestrial base station may transmit a system information block (SIB) to terminals located in the area managed by AMF2 (S607). The terminals located in the area of AMF2 may receive the SIB from the non-terrestrial base station.

According to the present disclosure, an AMF can proceed with an NG setup procedure with a non-terrestrial base station installed in a satellite that starts providing services to a management area and can establish an NG interface. Accordingly, the non-terrestrial base station can promptly acquire information required for providing services to the management area from the AMF and can promptly provide services to terminals located in the management area.

In addition, according to the present disclosure, the AMF can proceed with an NG removal procedure with the non-terrestrial base station that ends service provision for the management area and can release the NG interface. Accordingly, the non-terrestrial base station can promptly deliver UE context information required for providing services to the management area to the AMF, so that continuous service can be provided to the terminals by another non-terrestrial base station.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a non-terrestrial base station, comprising:
establishing a stream control transmission protocol (SCTP) association with a first access and mobility management function (AMF) entity;
receiving, based on the established SCTP association, a next generation (NG) setup command message from the first AMF entity;
establishing an NG interface with the first AMF entity according to the NG setup command message; and
transmitting an NG setup complete message to the first AMF entity upon completing establishment of the NG interface.

2. The method of claim 1, wherein the NG setup command message includes at least one of information on a globally unique AMF identifier (GUAMI) or information on tracking areas of the non-terrestrial base station.

3. The method of claim 1, further comprising: before receiving the NG setup command message from the first AMF entity based on the established SCTP association, establishing a feeder link between the non-terrestrial base station and a gateway connected to the first AMF entity.

4. The method of claim 1, further comprising:
receiving an NG removal command message from a second AMF entity;
removing the NG interface according to the NG removal command message; and
transmitting an NG removal complete message to the second AMF entity upon completing removal of the NG interface.

5. The method of claim 4, wherein the NG removal command message includes information on a transport network layer (TNL) list for establishing a new NG interface of a neighbor AMF entity, and the NG removal complete message includes user equipment (UE) context information of a terminal whose mobility handling has not been completed by the non-terrestrial base station.

6. A method of a first access and mobility management function (AMF) entity, comprising:
receiving movement path information including information on a time-based location of a non-terrestrial base station from an operation and maintenance center;
determining a start time of service provision of the non-terrestrial base station for a management area based on the movement path information; and
performing a next generation (NG) setup procedure to establish an NG interface with the non-terrestrial base station based on the determined start time of service provision.

7. The method of claim 6, wherein the performing of the NG setup procedure comprises:
transmitting an NG setup command message to the non-terrestrial base station;
establishing the NG interface based on the NG setup command message; and
receiving an NG setup complete message from the non-terrestrial base station upon completion of establishment of the NG interface.

8. The method of claim 7, wherein the NG setup command message includes at least one of information on a globally unique AMF identifier (GUAMI) or information on tracking areas of the non-terrestrial base station.

9. The method of claim 6, further comprising: before performing the NG setup procedure, receiving information on tracking areas managed by the non-terrestrial base station from the operation and maintenance center,
wherein the first AMF entity performs the NG setup procedure when a tracking area is included in the management area.

10. The method of claim 6, further comprising: before performing the NG setup procedure, establishing a stream control transmission protocol (SCTP) association with the non-terrestrial base station.

11. The method of claim 6, further comprising:
determining an end time of service provision of the non-terrestrial base station for the management area based on the movement path information; and
performing an NG removal procedure to remove the NG interface with the non-terrestrial base station based on the determined end time of service provision.

12. The method of claim 11, wherein the performing of the NG removal procedure comprises:
transmitting an NG removal command message to the non-terrestrial base station;
removing the NG interface according to the NG removal command message; and
receiving an NG removal complete message from the non-terrestrial base station upon completion of the removal of the NG interface.

13. The method of claim 12, wherein the NG removal command message includes information on a transport network layer (TNL) list of a neighbor AMF entity for establishing a new NG interface, and the NG removal complete message includes user equipment (UE) context information of a terminal whose mobility handling has not been completed by the non-terrestrial base station.

14. A non-terrestrial base station comprising at least one processor, wherein the at least one processor causes the non-terrestrial base station to perform:
establishing a stream control transmission protocol (SCTP) association with a first access and mobility management function (AMF) entity;
receiving, based on the established SCTP association, a next generation (NG) setup command message from the first AMF entity;
establishing an NG interface with the first AMF entity according to the NG setup command message; and
transmitting an NG setup complete message to the first AMF entity upon completing establishment of the NG interface.

15. The non-terrestrial base station of claim 14, wherein the NG setup command message includes at least one of information on a globally unique AMF identifier (GUAMI) or information on tracking areas of the non-terrestrial base station.

16. The non-terrestrial base station of claim 14, wherein the at least one processor further causes the non-terrestrial base station to perform: before receiving the NG setup command message from the first AMF entity based on the established SCTP association, establishing a feeder link between the non-terrestrial base station and a gateway connected to the first AMF entity.

17. The non-terrestrial base station of claim 14, wherein the at least one processor further causes the non-terrestrial base station to perform:
receiving an NG removal command message from a second AMF entity;
removing the NG interface according to the NG removal command message; and
transmitting an NG removal complete message to the second AMF entity upon completing removal of the NG interface.

18. The non-terrestrial base station of claim 17, wherein the NG removal command message includes information on a transport network layer (TNL) list for establishing a new NG interface of a neighbor AMF entity, and the NG removal complete message includes user equipment (UE) context information of a terminal whose mobility handling has not been completed by the non-terrestrial base station.
